(19) United States
(12) Patent Application Publication
(10) Pub. No.: US 2024/0331454 A1
(43) Pub. Date: Oct. 3, 2024

(54) SYSTEM, METHOD, AND COMPUTER-READABLE STORAGE MEDIUM

(71) Applicant: HONDA MOTOR CO.,LTD., Tokyo (JP)

(72) Inventors: Satoshi MATSUI, Saitama (JP); Shinya WATANABE, Saitama (JP)

(21) Appl. No.: 18/614,720

(22) Filed: Mar. 24, 2024

(30) Foreign Application Priority Data
Mar. 29, 2023 (JP) 2023-052606

(51) Int. Cl. G07C 5/00; B60L 58/30; G07C 5/08

(52) U.S. Cl. CPC G07C 5/006; B60L 58/30; G07C 5/0808; B60L 2240/642; B60L 2240/645; B60L 2260/20

(57) ABSTRACT

A system includes an acquisition unit which acquires information indicating working history of each of a plurality of fuel cells; an estimation unit which estimates deterioration degrees of a plurality of members of the plurality of fuel cells based on the working history; and a recommendation unit which recommends that which other fuel cell should replace a first fuel cell of the plurality of fuel cells, based on the deterioration degrees. The method includes acquiring information indicating working history of each of a plurality of fuel cells; estimating deterioration degrees of a plurality of members of the plurality of fuel cells based on the working history; and recommending that which other fuel cell should replace a first fuel cell of the plurality of fuel cells, based on the deterioration degrees.

The contents of the following Japanese patent application(s) are incorporated herein by reference:
NO. 2023-052606 filed in JP on Mar. 29, 2023.

### BACKGROUND

### 1. Technical Field

The present invention relates to a system, a method, and a computer-readable storage medium.

### 2. Related Art

Recently, an effort has been made to considerably reduce waste generation by preventing waste generation, reducing, recycling, and reusing the waste. To achieve this, waste reduction by reusing and/or repurposing fuel cells has been studied and developed.

### PRIOR ART DOCUMENT

### Patent Document

Patent Document 1: Japanese Laid-Open Patent Publication No. 2020-119236
Patent Document 2: Japanese Patent No. 4369825
Patent Document 3: Japanese Patent No. 6135545
Patent Document 4: Japanese Laid-Open Patent Publication No. 2009-198393
Patent Document 5: Japanese Laid-Open Patent Publication No. 2009-294004
Patent Document 6: International Publication WO 2021/111726

### BRIEF DESCRIPTION OF THE DRAWINGS

FIG. 1 conceptually shows how a maintenance system 190 in one embodiment is utilized.

FIG. 2 shows an exemplary configuration of a movable object system 100.

FIG. 3 shows an exemplary configuration of a system 180.

FIG. 4 shows a data structure of working history information of a movable object 10 stored in a storage unit 390 of the system 180.

FIG. 5 is exemplary coefficient information used by an estimation unit 320 to calculate a deterioration degree.

FIG. 6 shows a data structure of deterioration information of a fuel cell 270 stored in the storage unit 390.

FIG. 7 is a flowchart related to a method performed in the system 180.

FIG. 8 shows an example of a computer 2000.

### DESCRIPTION OF EXEMPLARY EMBODIMENTS

Hereinafter, embodiments of the present invention will be described. However, the following embodiments are not for limiting the invention according to the claims. In addition, not all of the combinations of features described in the embodiments are essential to the solution of the invention.

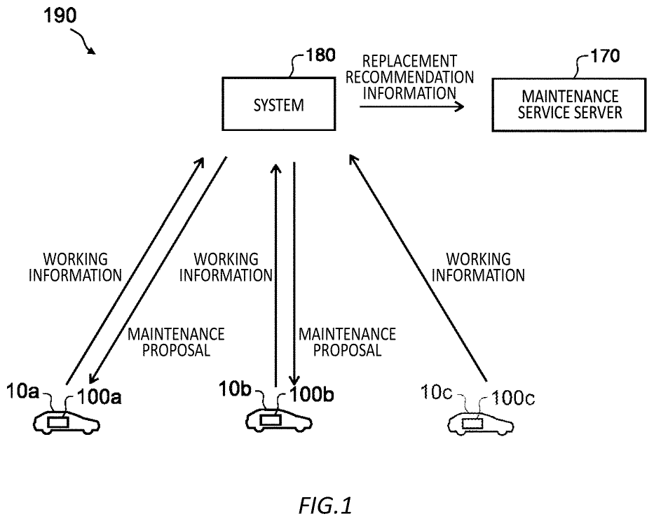

FIG. 1 conceptually shows how a maintenance system 190 in one embodiment is utilized. The maintenance system 190 includes a system 180, a plurality of movable objects including a movable object 10a, a movable object 10b, and a movable object 10c, and a maintenance service server 170.

In the present embodiment, the movable object 10a, the movable object 10b, and the movable object 10c are vehicles equipped with fuel cells. The movable object 10a, the movable object 10b, and the movable object 10c include a movable object system 100a, a movable object system 100b, and a movable object system 100c, respectively. Each of the movable object system 100a, the movable object system 100b, and the movable object system 100c is capable of communicating with the system 180 via a mobile communication network. In the present embodiment, the plurality of movable objects including the movable object 10a, movable object 10b, and the movable object 10c may be collectively referred to as a “movable object 10”, and the plurality of movable object systems including the movable object system 100a, the movable object system 100b, and the movable object system 100c may be collectively referred to as a “movable object system 100”.

The movable object system 100 includes a fuel cell and a battery as a power supply. The movable object 10 travels on electrical power supplied from the fuel cell and the battery. The movable object system 100 periodically transmits, to the system 180, working information of the movable object 10 at a plurality of times. The working information includes driving information of the movable object 10 such as location of the movable object 10 or velocity of the movable object 10, working information of the fuel cell such as output current and temperature of the fuel cell provided in the movable object system 100, and operation information such as information to indicate an opening degree of an accelerator provided in the movable object 10.

The system 180 accumulates, as working history, the pieces of working information that are periodically transmitted from the movable object system 100. The system 180 estimates deterioration degrees of a plurality of members of the fuel cell provided in the movable object 10 based on the working history. For example, the system 180 estimates the deterioration degrees of the plurality of members of the fuel cell provided in the movable object 10, based on an amount of variation in the output current of the fuel cell or temperature history of the fuel cell.

In addition, the system 180 divides the movable objects 10 into a plurality of groups according to traveling modes of the movable objects 10. For example, the movable object system 100 divides the movable objects 10 into a group of movable objects that mainly travel on a highway and a group of movable objects that mainly travel on an ordinary road based on location history of the movable objects 10 included in the driving history and map information. The system 180 estimates deterioration degrees of the plurality of members of the fuel cells provided in the movable objects 10 based on the driving history of the movable objects 10 divided into each group.

For example, the system 180 determines that the electrocatalyst of the fuel cell provided in the movable object 10a is more deteriorated than the electrolytic membrane of the fuel cell provided in the movable object 10a, and also determines that the deterioration degree of the electrocatalyst of the fuel cell provided in the movable object 10a has reached a predetermined threshold value at which replacement of the fuel cell should be proposed. On the other hand, the system 180 determines that the electrolytic membrane of the fuel cell provided in the movable object 10b is more deteriorated than the electrocatalyst of the fuel cell provided in the movable object 10b, and also determines that the deterioration degree of the electrolytic membrane of the fuel cell provided in the movable object 10b has reached a predetermined threshold value at which replacement of the fuel cell should be proposed. In this case, the system 180 proposes to users of the movable object 10a and the movable object 10b to replace the fuel cells. In addition, the system 180 transmits, to a maintenance service server 170, replacement recommendation information that proposes to replace the fuel cell of the movable object 10a with the fuel cell of the movable object 10b. The system 180 may transmit, to a maintenance service server 170, replacement recommendation information that recommends replacing the fuel cell of the movable object 10b with the fuel cell of the movable object 10a.

According to the maintenance system 190, the fuel cell of the movable object 10b that has a less deteriorated electrocatalyst can be used in the movable object 10a in which an electrocatalyst is more prone to deterioration. In addition, the fuel cell of the movable object 10a that has a less deteriorated electrolytic membrane can be used in the movable object 10b in which an electrolytic membrane is more prone to deterioration. It is possible to prevent disposal of a fuel cell that has not been fully used due to deterioration of a particular member of the fuel cell being progressed. Thus, the fuel cell provided in the movable object 10 can be appropriately reused.

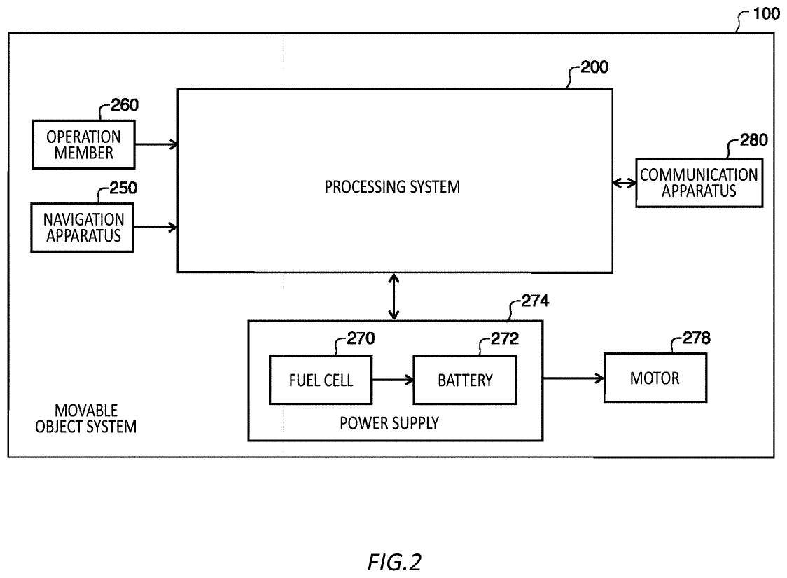

FIG. 2 shows an exemplary configuration of a movable object system 100. The movable object system 100 includes a processing system 200, a communication apparatus 280, a navigation apparatus 250, an operation member 260, a power supply 274, and a motor 278. The processing system 200 may be implemented by one or more computers.

The motor 278 operates on the electrical power supplied from the power supply 274 to generate driving force for driving the wheels provided in the movable object 10. The power supply 274 includes a fuel cell 270 and a battery 272. The fuel cell 270 is, for example, a polymer electrolyte fuel cell (PEFC).

The communication apparatus 280 communicates via a mobile communication network. The communication apparatus 280 is responsible for communication between the system 180 and the movable object system 100. The navigation apparatus 250 provides navigation information to a user of the movable object 10. The navigation apparatus 250 outputs, to the processing system 200, information indicating a current location of the movable object 10. The communication apparatus 280 receives maintenance proposal information transmitted from the system 180. The information related to a control parameter may be, for example, an update program to be reprogrammed, or may be identification information of one control parameter among a plurality of predetermined control parameters.

The processing system 200 acquires the working information of the fuel cell 270 and the working information of the battery 272 from the power supply 274. The working information of the fuel cell 270 includes information indicating output current of the fuel cell 270, information indicating temperature, or the like. The working information of the battery 272 includes information indicating SOC of the battery 272 or the like. The processing system 200 acquires operation information to operate traveling of the movable object 10. For example, the processing system 200 acquires operation information of an accelerator pedal. The operation information of the accelerator pedal includes, for example, information indicating an accelerator opening degree. The processing system 200 may acquire operation information of various other operation members 260 such as a brake pedal. The processing system 200 transmits, to the system 180 through the communication apparatus 280, information indicating the current location of the movable object 10 output by the navigation apparatus 250.

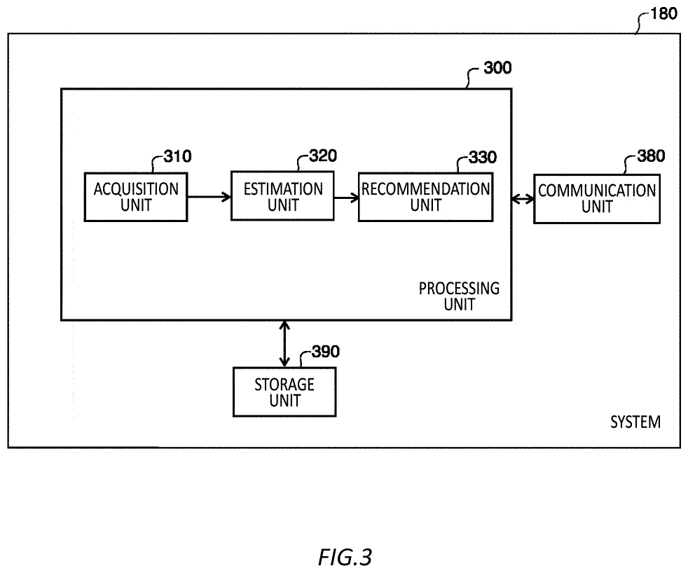

FIG. 3 shows an exemplary configuration of a system 180. The system 180 includes a processing unit 300, a communication unit 380, and a storage unit 390. The system 180 may be implemented by one or more computers.

The communication unit 380 communicates with the movable object 10 via the mobile communication network. The storage unit 390 stores information required for the operation of the system 180. The storage unit 390 is configured to include a non-volatile storage medium.

The processing unit 300 includes an acquisition unit 310, an estimation unit 320, and a recommendation unit 330. The acquisition unit 310 acquires information indicating the working history of each of the plurality of fuel cells 270. The estimation unit 320 estimates the deterioration degrees of the plurality of members of the plurality of fuel cells 270 based on the working history acquired by the acquisition unit 310. The recommendation unit 330 recommends which other fuel cell 270 of the plurality of fuel cells 270 should replace the first fuel cell 270 of the plurality of fuel cells 270, based on the deterioration degrees of the plurality of members of the plurality of fuel cells 270 estimated by the estimation unit 320.

If the deterioration degree of the first member is higher than the deterioration degree of the second member in the first fuel cell 270, the recommendation unit 330 recommends replacing the first fuel cell 270 with a fuel cell 270, among other fuel cells 270, that has the first member with a lower deterioration degree than the deterioration degree of the second member. The first member may be an electrocatalyst in the fuel cell 270, and the second member may be an electrolytic membrane in the fuel cell 270.

The present embodiment describes a mode in which a plurality of fuel cells 270 are provided in a plurality of movable objects 10. In the mode in which the plurality of fuel cells 270 are provided in the plurality of movable objects 10, “other fuel cells” may include fuel cells for reuse that are stocked after they were used in other movable objects 10 in the past. “Other fuel cells” may include fuel cells 270 provided in other movable objects 10. The recommendation unit 330 may recommend which fuel cell 270 of the fuel cells 270 stocked for reuse or the fuel cells 270 provided in other movable objects 10 should replace the fuel cell 270 provided in the first movable object 10.

In the mode in which the plurality of fuel cells 270 are provided in the plurality of movable objects 10, the working history may include information indicating at least one of the working history for each of the plurality of fuel cells 270 or the operation history related to traveling of the plurality of movable objects 10. The estimation unit 320 may estimate the deterioration degree of the plurality of members of the plurality of fuel cells 270 based on at least one of the working history or the operation history.

The estimation unit 320 may estimate a traveling mode of each of the plurality of movable objects 10 based on the working history of each of the plurality of movable objects 10 and may estimate the deterioration degrees of the plurality of members of the plurality of fuel cells 270 based on the traveling mode for each of the plurality of movable objects 10. The traveling mode may include a mode which is based on the type of roads on which each of the plurality of the movable objects 10 have mainly traveled.

The traveling mode may include a mode in which each of the plurality of movable objects 10 mainly travels on a highway and a mode in which it mainly travels on an ordinary road. The plurality of members may include an electrocatalyst provided in the fuel cell 270. The estimation unit 320 may estimate the deterioration degree of the electrocatalyst in the fuel cell 270 provided in the movable object 10 that has mainly traveled on an ordinary road to be higher than the deterioration degree of the electrocatalyst in the fuel cell 270 provided in the movable object 10 that has mainly traveled on a highway.

The traveling mode may include a mode in which each of the plurality of movable objects 10 travels on an uphill road having an upward gradient that is higher than a predetermined value. The plurality of members may include an electrolytic membrane of the fuel cell 270. The estimation unit 320 may estimate the deterioration degree of the electrolytic membrane of the fuel cell 270 provided in the movable object 10 that has a larger traveling amount on an uphill road, to be higher. The traveling mode may include a mode in which each of the plurality of movable objects 10 travels on a downhill road having a downward gradient that is higher than a predetermined value. The plurality of members may include an electrocatalyst of the fuel cell 270. The estimation unit 320 may estimate the deterioration degree of the electrocatalyst of the fuel cell 270 provided in the movable object 10 that has a larger traveling amount on a downhill road, to be higher.

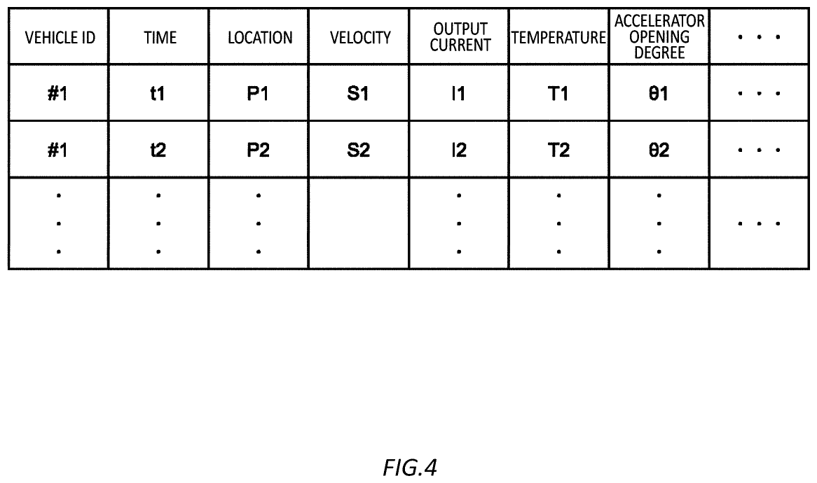

FIG. 4 shows a data structure of working history information of the movable object 10 stored in the storage unit 390 of the system 180. The working history information is the information to make an association among a vehicle ID for identifying a vehicle, time, location of the movable object 10, velocity of the movable object 10, output current of the fuel cell 270, temperature of the fuel cell 270, and an accelerator opening degree. The working history information is transmitted from the movable object 10, received by the communication unit 380, acquired by the acquisition unit 310, and stored in the storage unit 390.

The estimation unit 320 estimates the deterioration degree of each of the plurality of members provided in the fuel cell 270. In the present embodiment, the members for which the deterioration degree is estimated are the electrocatalyst and the electrolytic membrane among the members provided in the fuel cell 270.

The deterioration of the electrocatalyst includes deterioration caused by dissolution or cohesion of catalyst metal. The dissolution or cohesion of the catalyst metal is likely to occur during output variation, start, and stop of the fuel cell 270. Accordingly, the estimation unit 320 estimates that the deterioration of the electrocatalyst would progress due to the output variation, start, and stop of the fuel cell 270. For example, the estimation unit 320 estimates the deterioration degree of the electrocatalyst according to a predetermined calculation formula for the deterioration degree that uses an amount of output variation and the number of times of the start and stop of the fuel cell 270 as parameters.

An electrolytic membrane for a fuel cell generally has low high-temperature resistance, and the longer it is exposed to high temperature, the more it deteriorates. In addition, an electrolytic membrane for a fuel cell may be mechanically deteriorated, for example, by repeated expansion and drying of the electrolytic membrane due to the output variation of the fuel cell 270. Accordingly, the estimation unit 320 estimates that the deterioration of the electrolytic membrane would progress due to the temperature of the fuel cell 270 and the output variation of the fuel cell 270. For example, the estimation unit 320 estimates the deterioration degree of the electrolytic membrane according to a predetermined calculation formula for the deterioration degree that uses the temperature and an amount of output variation of the fuel cell 270 as parameters.

In another mode, the estimation unit 320 estimates deterioration degrees of the electrocatalyst and the electrolytic membrane based on the traveling mode of the movable object 10. The estimation unit 320 sets up, as examples of the traveling mode, a plurality of groups that are based on the working history information of the movable objects 10. The groups include (i) a group of movable objects that mainly travel on a highway, (ii) a group of movable objects that mainly travel on an ordinary road, (iii) a group of movable objects that have a large traveling amount on an uphill road, and (iv) a group of movable objects that have a large traveling amount on a downhill road, and so on. Each group may be composed of at least the same kind of vehicles. Accordingly, different kinds of vehicles belong to different groups.

The group of movable objects that mainly travel on a highway may include, for example, the movable objects 10 that have a higher ratio of traveling distance on a highway to the total traveling distance or a higher ratio of traveling time on a highway to the total traveling time than a predetermined value. In the same way, the group of movable objects that mainly travel on an ordinary road may include, for example, the movable objects 10 that have a higher ratio of traveling distance on an ordinary road to the total traveling distance or a higher ratio of traveling time on an ordinary road to the total traveling time than a predetermined value. In the same way, the group of movable objects that have a large traveling amount on an uphill road may include, for example, the movable objects 10 that have a higher ratio of traveling distance on an uphill road to the total traveling distance or a higher ratio of traveling time on an uphill road to the total traveling time than a predetermined value. In the same way, the group of movable objects that have a large traveling amount on a downhill road may include, for example, the movable objects 10 that have a higher ratio of traveling distance on a downhill road to the total traveling distance or a higher ratio of traveling time on a downhill road to the total traveling time than a predetermined value.

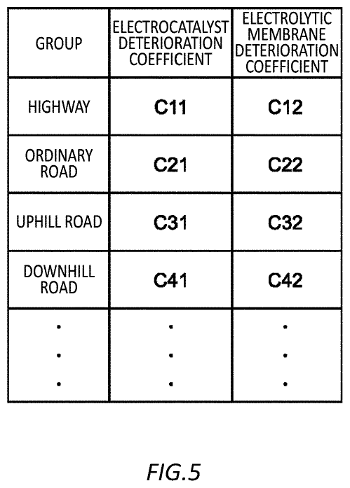

The estimation unit 320 estimates the deterioration degree of the electrocatalyst according to a calculation formula for the deterioration degree of the electrocatalyst that is determined in each group and that uses the traveling distance as a parameter. In the same way, the estimation unit 320 estimates the deterioration degree of the electrolytic membrane according to a calculation formula for the deterioration degree of the electrolytic membrane that is determined in each group and that uses the traveling distance as a parameter. Calculation of the deterioration degree of each of the electrocatalyst and the electrolytic membrane will be described in connection with FIG. 5.

FIG. 5 is exemplary coefficient information used by an estimation unit 320 to calculate a deterioration degree. The coefficient information includes groups, electrocatalyst deterioration coefficients, and electrolytic membrane deterioration coefficients. The electrocatalyst deterioration coefficient and the electrolytic membrane deterioration coefficient indicate a deterioration degree per unit traveling distance. For example, the electrocatalyst deterioration coefficient and the electrolytic membrane deterioration coefficient are the coefficients that are respectively multiplied by the traveling distance in the calculation formula for the deterioration degree.

When traveling on a highway, the output variation of the fuel cell 270 is relatively small. Therefore, the calculation formula for the deterioration degree of the group of movable objects that mainly travel on a highway is set to give a relatively low deterioration degree of the electrocatalyst per unit traveling distance. Specifically, a relatively small value is set for C11 in FIG. 5.

Meanwhile, when traveling on an ordinary road, the output variation of the fuel cell 270 is likely to increase due to frequent stop-and-go traffic caused by congestion, traffic lights, or the like. Therefore, the calculation formula for the deterioration degree of the group of movable objects that mainly travel on an ordinary road is set to give a higher deterioration degree of the electrocatalyst per unit traveling distance compared to the deterioration degree of the electrocatalyst per unit traveling distance of the group of movable objects that mainly travel on a highway. Specifically, a relatively large value is set for C21 and C22 in FIG. 5. More specifically, a larger value is set for C21 than a value for C11 in FIG. 5.

When traveling on an uphill road, the output of the fuel cell 270 is particularly high. Therefore, the calculation formula for the deterioration degree of the group of movable objects that have a large traveling amount on an uphill road is set to give a relatively high deterioration degree of the electrocatalyst per unit traveling distance. Since the fuel cell 270 becomes hot when traveling on an uphill road, the calculation formula for the deterioration degree of the group of movable objects that have a large traveling amount on an uphill road is also set to give a high deterioration degree of the electrolytic membrane per unit traveling distance. Specifically, a relatively large value is set for C31 and C32 in FIG. 5. For example, a larger value is set for C32 than a value for C22.

When traveling on a downhill road, the battery 272 may be fully charged due to regenerative braking. Since the fuel cell 270 significantly deteriorates by operation at low output, the fuel cell 270 is stopped when the battery 272 is fully charged. Therefore, the calculation formula for the deterioration degree of the group of movable objects that have a large traveling amount on a downhill road is set to give a high deterioration degree of the electrocatalyst per unit traveling distance. Specifically, a relatively large value is set for C41 in FIG. 5. More specifically, a larger value is set for C41 than a value for C11. In the same way, since start and stop of the fuel cell 270 are likely to occur when traveling on a downhill road, the calculation formula for the deterioration degree of the group of movable objects that have a large traveling amount on a downhill road is set to give a high deterioration degree of the electrolytic membrane per unit traveling distance.

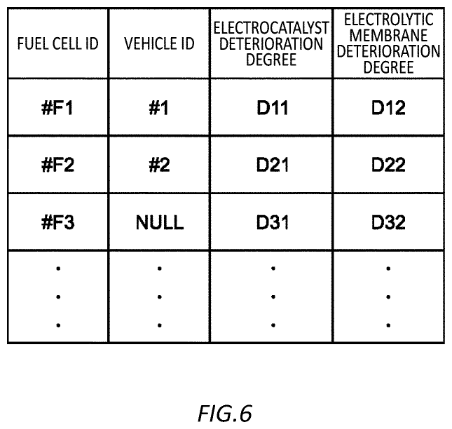

FIG. 6 shows a data structure of deterioration information of a fuel cell 270 stored in the storage unit 390. The deterioration information is the information to make an association among a fuel cell ID, a vehicle ID, an electrocatalyst deterioration degree, and an electrolytic membrane deterioration degree.

The fuel cell ID is information to identify a fuel cell 270. A fuel cell having the vehicle ID set as NULL value indicates that the fuel cell is stocked in a maintenance service center for reuse. A fuel cell having the vehicle ID set as values other than NULL value indicates that the fuel cell is mounted on the movable objects 10. The electrocatalyst deterioration degree is the deterioration degree of the electrocatalyst estimated by the estimation unit 320. The electrolytic membrane deterioration degree is the deterioration degree of the electrolytic membrane estimated by the estimation unit 320.

The estimation unit 320 may calculate, after each predetermined time interval, the deterioration degree of the electrocatalyst and the deterioration degree of the electrolytic membrane in each movable object 10 based on the working history information, and may update the deterioration information according to the calculated deterioration degrees. The estimation unit 320 may calculate, at each predetermined increase in the traveling distance of a movable object 10, the deterioration degree of the electrocatalyst and the deterioration degree of the electrolytic membrane based on the working history information of the movable object 10 that had the predetermined increase in the traveling distance, and may update the deterioration information according to the calculated deterioration degrees.

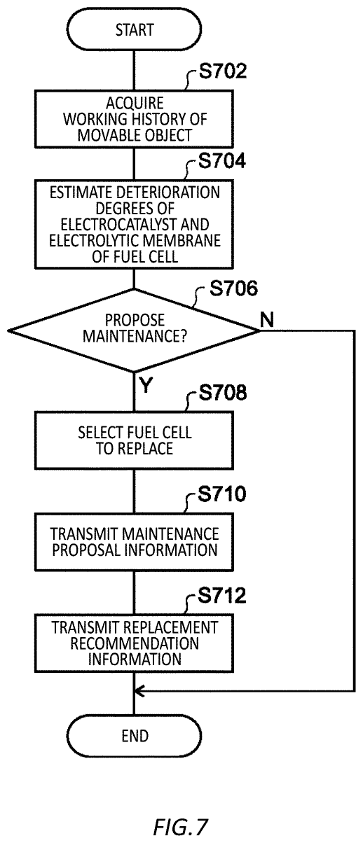

FIG. 7 is a flowchart related to a method performed in the system 180. In S702, the acquisition unit 310 acquires the working history of the movable object. Specifically, the acquisition unit 310 acquires the working history information from the storage unit 390. In S704, the estimation unit 320 of the fuel cell 270 estimates the deterioration degree of the electrocatalyst and the deterioration degree of the electrolytic membrane. The estimation unit 320 estimates the deterioration degree of the electrocatalyst and the deterioration degree of the electrolytic membrane according to the predetermined calculation formula for the deterioration degree as described in connection with FIG. 4, FIG. 5, and the like.

In S706, the recommendation unit 330 determines whether to propose the maintenance of the fuel cell. For example, the recommendation unit 330 determines to propose the maintenance of the fuel cell if one of the deterioration degree of the electrocatalyst or the deterioration degree of the electrolytic membrane has reached a predetermined value to propose the maintenance of the fuel cell.

Here in S706, the recommendation unit 330 may determine to propose the maintenance of the fuel cell if one of the deterioration degree of the electrocatalyst or the deterioration degree of the electrolytic membrane has reached a predetermined value to propose the maintenance of the fuel cell and also if another of the deterioration degrees has not reached the predetermined value to propose the maintenance of the fuel cell, and may determine not to propose the maintenance of the fuel cell if both of the deterioration degree of the electrocatalyst and the deterioration degree of the electrolytic membrane have reached the predetermined value to propose the maintenance of the fuel cell. When both deterioration degrees of the electrocatalyst and the electrolytic membrane have reached the predetermined value, their deterioration may have progressed evenly. In this case, by continuously using the fuel cell 270 until the end of its life, maintenance man hours may be reduced.

When the recommendation unit 330 determines in S706 to propose maintenance of the fuel cell provided in the movable objects 10, it refers to the deterioration information to select a fuel cell to be used to replace the fuel cell 270 of the movable objects 10. For example, when the deterioration degree of the electrocatalyst of the fuel cell provided in the movable object 10 has reached a predetermined threshold value while the deterioration degree of the electrolytic membrane of the fuel cell provided in the movable object 10 has not reached the predetermined threshold value, the recommendation unit 330 refers to the deterioration information and selects a fuel cell having at least a deterioration degree of an electrocatalyst that has not reached the predetermined threshold value, as a fuel cell to be used to replace the fuel cell in the movable object 10. The recommendation unit 330 may preferentially select a fuel cell that is not mounted on another movable object 10 rather than a fuel cell that is mounted on another movable object 10, as a fuel cell to be used to replace the fuel cell 270 in the movable object 10. For example, the recommendation unit 330 may preferentially select a fuel cell that is stocked in the maintenance service center as a fuel cell to be used to replace the fuel cell in the movable object 10.

In S710, the recommendation unit 330 transmits maintenance proposal information to the movable object 10. If a fuel cell mounted on another movable object 10 has been selected in S708 as a fuel cell to be used to replace the fuel cell 270 in the movable objects 10, the recommendation unit 330 transmits the maintenance proposal information to another movable object 10 as well.

In S712, the recommendation unit 330 transmits replacement recommendation information to the maintenance service server 170. The replacement recommendation information may include at least identification information of the fuel cell 270 to be replaced and identification information of the movable object 10 on which said fuel cell 270 is mounted as well as identification information of the fuel cell selected in S708.

In the maintenance system 190 described above, the movable object 10 is a vehicle. However, any movable object other than the vehicle may be applied as the movable object 10.

According to the maintenance system 190 described above, an appropriate fuel cell can be selected to be used to replace the fuel cell 270 provided in the movable object 10, depending on the difference in the deterioration degrees of the plurality of members in said fuel cell 270. Thus, the fuel cell can be reused depending on the difference in the deterioration degrees of the plurality of members in the fuel cell 270, allowing longer usage of the fuel cell.

The embodiments described above have explained the mode in which the plurality of fuel cells 270 are provided in the plurality of movable objects 10, and the working history is accumulated for each movable object 10. However, the present invention is not limited to the mode in which the fuel cell 270 is provided in the movable object 10, and may adopt the mode in which the working history is accumulated for each fuel cell 270. For example, a mode may be adopted in which the working history information described in connection with FIG. 4 makes an association among the identification information of the fuel cell 270, time, and the working information including output current and temperature of the fuel cell 270, and the fuel cell 270 to replace is selected based on the working information of the fuel cell 270.

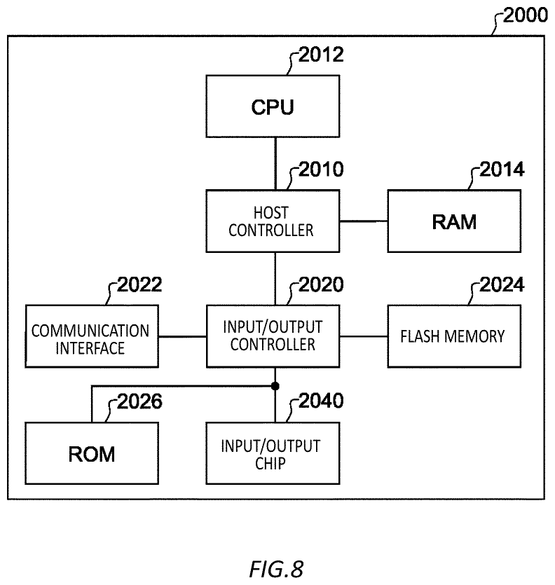

FIG. 8 illustrates an example of a computer 2000 in which a plurality of embodiments of the present invention may be entirely or partially embodied. The program installed in the computer 2000 can cause the computer 2000 to function as each unit in the system 180 or the movable object system 100, or as an apparatus such as the system 180 or each unit of such an apparatus, can cause the computer 2000 to perform operations associated with such a system or each unit of such a system or such an apparatus or each unit of such an apparatus according to the embodiments and/or can cause the computer 2000 to perform the process or steps in such a process according to the embodiments. Such a program may be executed by a CPU 2012 in order to cause the computer 2000 to execute a specific operation associated with some or all of the processing procedures and the blocks in the block diagrams described herein.

The computer 2000 according to the present embodiment includes the CPU 2012 and a RAM 2014, which are mutually connected by a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via an input/output controller 2020.

A program that is installed in the computer 2000 and causes the computer 2000 to function as the system 180 may work on the CPU 2012 and the like to cause the computer 2000 to function as each unit of the system 180, respectively. Information processing described in these programs are read into the computer 2000 to cause the computer to function as each unit of the system 180, which is a specific means realized by cooperation of software and the various types of hardware resources described above. Then, with these specific means, by realizing computing or processing of information according to an intended use of the computer 2000 in the present embodiment, specific system 180 is constructed according to the intended use.

A program that is installed in the computer 2000 and causes the computer 2000 to function as the movable object system 100 may work on the CPU 2012 and the like to cause the computer 2000 to function as each unit of the movable object system 100, respectively. Information processing described in these programs are read into the computer 2000 to cause the computer to function as each unit of the movable object system 100, which is a specific means realized by cooperation of software and the various types of hardware resources described above. Then, with these specific means, by realizing computing or processing of information according to an intended use of the computer 2000 in the present embodiment, specific movable object system 100 is constructed according to the intended use.

While the present invention has been described by way of the embodiments, the technical scope of the present invention is not limited to the above described embodiments. It is apparent to persons skilled in the art that various alterations or improvements can be made to the above described embodiments. It is also apparent from description of the claims that the embodiments to which such alterations or improvements are made can be included in the technical scope of the present invention.

Each process of the operations, procedures, steps, and stages etc. in the apparatus, system, program, and method shown in the claims, specification, or diagrams can be executed in any order as long as the order is not indicated by “prior to”, “before”, or the like and as long as the output from a previous process is not used in a later process. Even if the operation flow is described using phrases such as “first” or “next” for the sake of convenience in the claims, specification, or drawings, it does not necessarily mean that the process must be performed in this order.

### EXPLANATION OF REFERENCES

100: movable object system
180: system;
170: maintenance service server;
190: maintenance system;
200: processing system;
250: navigation apparatus;
260: operation member;
270: fuel cell;
272: battery;
274: power supply;
278: motor;
280: communication apparatus;
300: processing unit;
310: acquisition unit;
320: estimation unit;
330: recommendation unit;
380: communication unit;
390: storage unit;
2000: computer;
2010: host controller;
2012: CPU;
2014: RAM
2020: input/output controller;
2022: communication interface;
2024: flash memory;
2026: ROM
2040: input/output chip.

What is claimed is:

1. A system, comprising:
an acquisition unit which acquires information indicating working history of each of a plurality of fuel cells;
an estimation unit which estimates deterioration degrees of a plurality of members of the plurality of fuel cells based on the working history acquired by the acquisition unit; and
a recommendation unit which recommends which other fuel cell of the plurality of fuel cells should replace a first fuel cell of the plurality of fuel cells, based on the deterioration degrees of the plurality of members of the plurality of fuel cells estimated by the estimation unit.

2. The system according to claim 1, wherein
if a deterioration degree of a first member is higher than a deterioration degree of a second member in the first fuel cell, the recommendation unit recommends replacing the first fuel cell with another fuel cell, among the plurality of fuel cells, that has the first member with a lower deterioration degree than a deterioration degree of the second member.

3. The system according to claim 2, wherein
the first member is an electrocatalyst of a fuel cell and the second member is an electrolytic membrane of a fuel cell.

4. The system according to claim 1, wherein
the plurality of fuel cells are provided in a plurality of movable objects,
the working history includes information indicating at least one of working history of each of the plurality of fuel cells or operation history related to traveling of the plurality of movable objects, and
the estimation unit estimates deterioration degrees of the plurality of members of the plurality of fuel cells based on the working history.

5. The system according to claim 1, wherein
the plurality of fuel cells are provided in a plurality of movable objects, and
the estimation unit estimates a traveling mode of each of the plurality of movable objects based on working history of each of the plurality of movable objects, and estimates deterioration degrees of the plurality of members of the plurality of fuel cells based on the traveling mode of each of the plurality of movable objects.

6. The system according to claim 5, wherein
the traveling mode includes a mode which is based on a type of road on which each of the plurality of movable objects has mainly traveled.

7. The system according to claim 6, wherein
the traveling mode includes a mode in which each of the plurality of movable objects mainly travels on a highway and a mode in which each of the plurality of movable objects mainly travels on an ordinary road,
the plurality of members include an electrocatalyst provided in the fuel cell, and
the estimation unit estimates a deterioration degree of an electrocatalyst of a fuel cell provided in a movable object among the plurality of movable objects that has mainly traveled on the ordinary road to be higher than a deterioration degree of an electrocatalyst of a fuel cell provided in a movable object among the plurality of movable objects that has mainly traveled on the highway.

8. The system according to claim 6, wherein
the traveling mode includes a mode in which each of the plurality of movable objects travels on an uphill road having an upward gradient that is higher than a predetermined value,
the plurality of members include an electrolytic membrane of the fuel cell, and
the estimation unit estimates a deterioration degree of an electrolytic membrane of a fuel cell provided in a movable object among the plurality of movable objects that has a larger traveling amount on the uphill road, to be higher.

9. The system according to claim 6, wherein
the traveling mode includes a mode in which each of the plurality of movable objects travels on a downhill road having a downward gradient that is higher than a predetermined value,
the plurality of members include an electrocatalyst of the fuel cell, and
the estimation unit estimates a deterioration degree of an electrocatalyst of ta fuel cell provided in a movable object among the plurality of movable objects that has a larger traveling amount on the downhill road, to be higher.

10. The system according to claim 4, wherein
the plurality of movable objects are vehicles.

11. The system according to claim 2, wherein
the plurality of fuel cells are provided in a plurality of movable objects,
the working history includes information indicating at least one of working history of each of the plurality of fuel cells or operation history related to traveling of the plurality of movable objects, and
the estimation unit estimates deterioration degrees of the plurality of members of the plurality of fuel cells based on the working history.

12. The system according to claim 3, wherein
the plurality of fuel cells are provided in a plurality of movable objects,
the working history includes information indicating at least one of working history of each of the plurality of fuel cells or operation history related to traveling of the plurality of movable objects, and
the estimation unit estimates deterioration degrees of the plurality of members of the plurality of fuel cells based on the working history.

13. The system according to claim 2, wherein
the plurality of fuel cells are provided in a plurality of movable objects, and
the estimation unit estimates a traveling mode of each of the plurality of movable objects based on working history of each of the plurality of movable objects, and estimates deterioration degrees of the plurality of members of the plurality of fuel cells based on the traveling mode of each of the plurality of movable objects.

14. The system according to claim 3, wherein
the plurality of fuel cells are provided in a plurality of movable objects, and
the estimation unit estimates a traveling mode of each of the plurality of movable objects based on working history of each of the plurality of movable objects, and estimates deterioration degrees of the plurality of members of the plurality of fuel cells based on the traveling mode of each of the plurality of movable objects.

15. The system according to claim 13, wherein
the traveling mode includes a mode which is based on a type of road on which each of the plurality of movable objects has mainly traveled.

16. The system according to claim 14, wherein
the traveling mode includes a mode which is based on a type of road on which each of the plurality of movable objects has mainly traveled.

17. The system according to claim 15, wherein
the traveling mode includes a mode in which each of the plurality of movable objects mainly travels on a highway and a mode in which each of the plurality of movable objects mainly travels on an ordinary road,
the plurality of members include an electrocatalyst provided in the fuel cell, and
the estimation unit estimates a deterioration degree of an electrocatalyst of a fuel cell provided in a movable object among the plurality of movable objects that has mainly traveled on the ordinary road to be higher than a deterioration degree of tan electrocatalyst of a fuel cell provided in a movable object among the plurality of movable objects that has mainly traveled on the highway.

18. The system according to claim 16, wherein
the traveling mode includes a mode in which each of the plurality of movable objects mainly travels on a highway and a mode in which each of the plurality of movable objects mainly travels on an ordinary road,
the plurality of members include an electrocatalyst provided in the fuel cell, and
the estimation unit estimates a deterioration degree of an electrocatalyst of a fuel cell provided in a movable object among the plurality of movable objects that has mainly traveled on the ordinary road to be higher than a deterioration degree of an electrocatalyst of a fuel cell provided in a movable object among the plurality of movable objects that has mainly traveled on the highway.

19. A method, comprising:
acquiring information indicating working history of each of a plurality of fuel cells;
estimating deterioration degrees of a plurality of members of the plurality of fuel cells based on the working history acquired by the acquiring; and
recommending which other fuel cell of the plurality of fuel cells should replace a first fuel cell of the plurality of fuel cells, based on the deterioration degrees of the plurality of members of the plurality of fuel cells estimated by the estimating.

20. A non-transitory computer-readable storage medium storing therein a program which causes a computer to function as:
an acquisition unit which acquires information indicating working history of each of a plurality of fuel cells;
an estimation unit which estimates deterioration degrees of a plurality of members of the plurality of fuel cells based on the working history acquired by the acquisition unit; and
a recommendation unit which recommends which other fuel cell of the plurality of fuel cells should replace a first fuel cell of the plurality of fuel cells, based on the deterioration degrees of the plurality of members of the plurality of fuel cells estimated by the estimation unit.
